(19) United States
(12) Patent Application Publication
(10) Pub. No.: US 2004/0152940 A1
(43) Pub. Date: Aug. 5, 2004

(54) Method of chemical decontamination

(76) Inventors: Kazushige Ishida, Hitachi (JP); Makoto Nagase, Mito (JP); Kazumi Anazawa, Hitachi (JP); Motohiro Aizawa, Hitachi (JP)

Correspondence Address: MCDERMOTT, WILL & EMERY, 600 13th Street, N.W., Washington, DC, 20005-3096, US

(21) Appl. No.: 10/744,102

(22) Filed: Dec. 24, 2003

(30) Foreign Application Priority Data
Dec. 24, 2002 (JP) 2002-371646

(51) Int. Cl. A62D 3/00

(52) U.S. Cl. 588/13

(57) ABSTRACT

It is an object of the present invention to provide a method of chemical decontamination which can remove iron oxalate deposited on a metallic material surface without extending a whole step of decontamination works.

The method of chemical decontamination of the present invention contains the reduction decontaminating step (9) for decontamination using the cation exchange resin column (7) by supplying a reduction decontaminating agent containing oxalic acid onto the decontamination area 1 of metallic part surface, and the subsequent reduction decontaminating agent decomposition steps (10) and (12) for decomposing the reduction decontaminating agent, wherein hydrogen peroxide is supplied onto the decontamination area 1 from the hydrogen peroxide solution tank 20 while blocking the passage towards the cation exchange resin column 7 by closing the valves 103a and 103b during the iron oxalate removal step (11) after suspending the reduction decontaminating agent decomposition step (after completion of the reduction decontaminating agent decomposition step A).

### FIELD OF THE INVENTION

The present invention relates to a method of chemical decontamination, which chemically removes a radionuclide from a surface of metallic part, e.g., that for a primary coolant system contaminated with the radionuclide.

### BACKGROUND OF THE INVENTION

One of the methods for removing iron oxalate deposited on a metallic material surface proposed so far uses an addition of around a 1% hydrogen peroxide solution, on completion of a reduction decontaminating agent decomposition step, which decomposes a reduction decontaminating agent containing oxalic acid (e.g., JP-A-2000-121791).

### SUMMARY OF THE INVENTION

One of the known methods for chemical decontamination of a water cooling nuclear power plant has used oxalic acid and hydrazine as reduction decontaminating agents to remove an oxide film on a metallic structural part for a nuclear reactor. In a boiling water reactor plant, for example, normally includes a structural material of carbon steel, stainless steel or the like. These plants, therefore, sometimes include a metallic material amenable to corrosion by oxalic acid, e.g., carbon steel, ferritic stainless steel or sensitized austenitic stainless steel, when the chemical decontamination with an agent containing oxalic acid, depending on area to be decontaminated. In such a case, iron oxalate may be deposited on the metallic material surface during decontamination to cause recontamination of the decontaminated part, when it takes radioactivity in system water.

The deposited iron oxalate will remain on the metallic material surface after the decontamination work is completed. When in-service chemical decontamination is carried out for a nuclear plant, the deposited iron oxalate may be thermally decomposed by hot water when the nuclear reactor is restarted to cause temporal electroconductivity increase or pH decrease of reactor water, which can exert an adverse effect on operational controllability of the reactor.

These exist the following problems in conventional techniques.

The conventional techniques are intended not only to remove iron oxalate deposited on a metallic material surface but also to form an oxide film on the surface. Therefore, the techniques need a relatively large quantity of high-concentration hydrogen peroxide solution in the oxidation treatment step for removing the iron oxalate and forming the oxide film, on completion of the reduction decontaminating agent decomposition step. As a result, a subsequent oxidation decontaminating agent decomposition step is additionally needed to decompose the high-concentration hydrogen peroxide solution incorporated for the oxidation treatment step. In other words, the reduction decontaminating agent decomposition step should be followed by the oxidation treatment step and oxidation decontaminating agent decomposition step. Moreover, it is also necessary to remove substances eluted out as a result of the treatment with hydrogen peroxide for removing iron oxalate.

As discussed above, the conventional techniques involve problems resulting from the whole decontamination works for an extended period. The in-service decontamination works, in particular, extend the plant shut-down period, leading to decreased availability factor of the plant.

It is an object of the present invention to provide a method of chemical decontamination which can remove iron oxalate deposited on a metallic material surface without extending the whole step of decontamination works.

The inventors of the present invention have found that a relatively small quantity of hydrogen peroxide solution of relatively low concentration is sufficient only for removing iron oxalate deposited on a metallic material surface in the chemical decontamination area (i.e., when the treatment is not intended to the extent of forming an oxide film on the surface). They have also found that re-deposition of removed iron oxalate can be prevented almost completely, when oxalic acid concentration becomes small to some extent.

The present invention removes, based on the above findings, iron oxalate deposited in a decontamination area during the reduction decontaminating agent decomposition step, i.e., before completion of the step, by supplying a minimum quantity of hydrogen peroxide or ozone of the lowest necessary concentration onto the decontamination area, when oxalic acid concentration becomes small to some extent, e.g., in the latter stage of the step, while temporarily suspending the step or in parallel with the step continuing without being suspended. Therefore, the present invention can quickly complete removal of iron oxalate before completion of the reduction decontaminating agent decomposition step (i.e., during the reduction decontaminating agent decomposition step), unlike the conventional technique, which tries to remove iron oxalate with the aid of hydrogen peroxide subsequent to completion of the step. Moreover, the present invention can also achieve, during the reduction decontaminating agent decomposition step subsequent to removal of iron oxalate, removal of substances eluted out as a result of incorporation of hydrogen peroxide or ozone. In this case, an ion exchange resin or an ion exchange membrane, which are normally used in a radioactive substance removal unit, can be prevented from being deteriorated by hydrogen peroxide or ozone by supplying hydrogen peroxide or ozone while blocking a passage to the unit.

The present invention, removing iron oxalate by the above procedure, can dispense with post-treatment steps downstream of the reduction decontaminating agent decomposition step, e.g., iron oxalate removing step in the presence of hydrogen peroxide or the like, a step for decomposing surplus hydrogen peroxide or the like and a step for removing eluted substances, unlike the conventional technique, which needs all of these post-treatment steps. This reduces process time for these post-treatment steps and hence shortens the total decontamination process.

Other objects, features and advantages of the invention will become apparent from the following description of the embodiments of the invention taken in conjunction with the accompanying drawings.

### BRIEF DESCRIPTION OF THE DRAWINGS

FIG. 1 is a system flow chart illustrating the chemical decontamination unit of the first embodiment of the present invention.

FIG. 2 is a system flow chart illustrating the water quality monitor, shown in FIG. 1, in detail.

FIG. 3 outlines the overall steps of the chemical decontamination method of the first embodiment of the present invention.

FIG. 4 shows the test results of iron oxalate deposition characteristics in an oxalic acid atmosphere.

FIG. 5 shows the test results of iron oxalate removal characteristics by hydrogen peroxide of low concentration.

FIG. 6 shows the test results of iron oxalate redeposition characteristics in an atmosphere of hydrogen peroxide incorporated.

### REFERENCE NUMERALS AND SIGNS

1 Decontamination area (area to be decontaminated)

7 Cation exchange resin column (radioactive substance removal unit)

9 Hydrogen peroxide injection pump

10 Hydrogen peroxide aqueous solution tank

11 Oxalic acid solution tank

12 Oxalic acid injection pump

20 Hydrogen peroxide aqueous solution tank

21 Hydrogen peroxide injection pump

300 Chemical decontamination unit

### DETAILED DESCRIPTION OF THE INVENTION

The embodiments of the present invention are described by referring to the attached drawings.

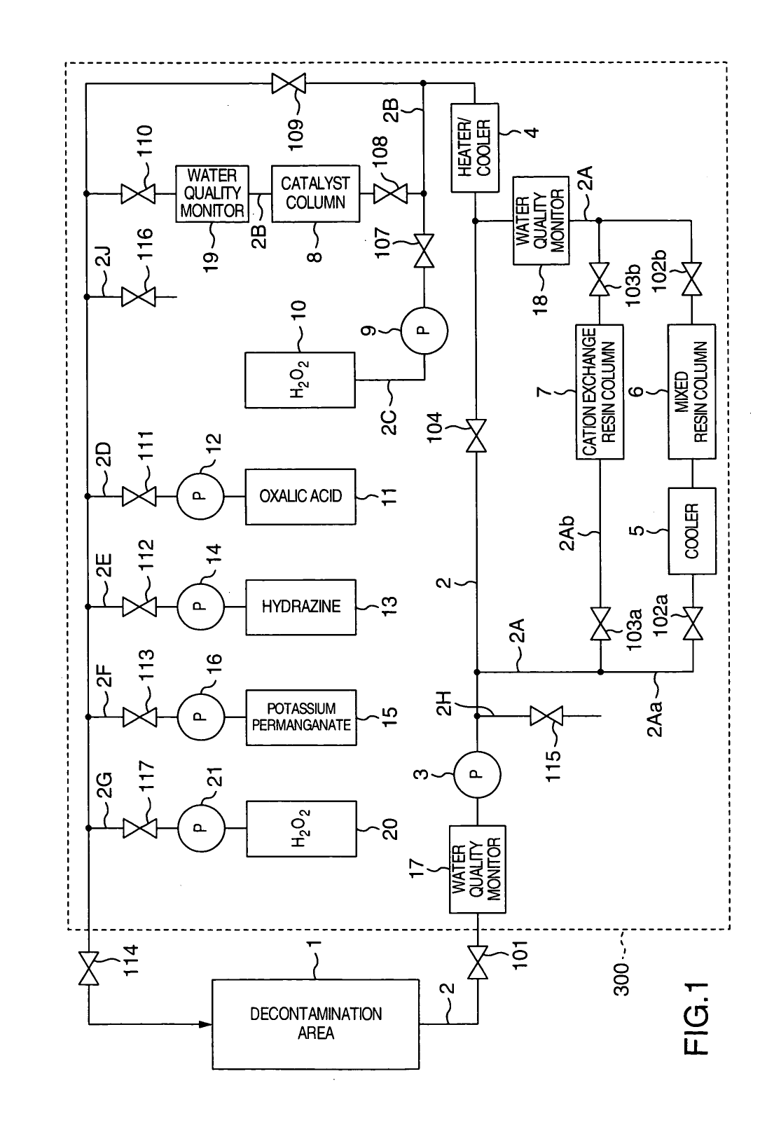

The first embodiment of the present invention is described by referring to FIGS. 1 to 6.

FIG. 1 is a system flow chart illustrating one example of the chemical decontamination unit 300 which is responsible for performing the chemical decontamination method of the present invention.

Referring to FIG. 1, the decontamination area 1 includes metallic parts (e.g. a steel containing at least one component selected from carbon steel, ferritic stainless steel and austenitic stainless steel) for components, pipings and systems containing them in a radionuclide-contaminated primary coolant system, and for other components and pipings. The piping 2 is connected to the area 1 in such a way to form a closed loop, in which the valves 101 and 114 are provided to isolate the decontamination area 1 from the chemical decontamination unit 300. The water quality monitor 17 for monitoring water quality in the decontamination area 1 and a circulation pump 3 for circulating system water are connected to the piping 2 downstream of the valve 101.

The piping 2A branches off from the piping 2 downstream of the circulation pump 2 to run in parallel to the piping 2. The piping 2Aa and 2Ab branch off from the piping 2A, and then merge before rejoining in the piping 2A.

The piping 2Aa is provided with a mixed bed resin column 6 for final purification (described later in detail) for the chemical decontamination, a system water cooler 5 upstream of the mixed bed resin column 6 to cool system water flowing through the column 6 to a given temperature level or below, and valves 102a and 102b upstream of the system water cooler 5 and downstream of the mixed bed resin column 6, respectively, for controlling flow of the system water (e.g., flow control or blocking or closing of the passage).

The piping 2Ab is provided with the cation exchange resin column 7, (which may be replaced by a cation exchange membrane), and the valves 103a and 103b upstream and downstream of the column 7, respectively, for controlling flow of the system water towards the column 7 (e.g., flow control or blocking of the passage), where the column 7 serves as a radioactive substance removal unit for removing radioactive ion or metallic ion eluted out during the chemical decontamination process, described later in detail.

The piping 2A is provided with the water quality monitor 18, downstream of the point at which the piping 2Aa and 2Ab join in the piping 2A (i.e., downstream of the cation exchange resin column 7 and mixed bed resin column 6), for confirming the radioactive ion or metallic ion removal conditions in the cation exchange resin column 7 and the mixed bed resin column 6.

The piping 2 is also provided with the valve 104 between the piping 2A branching-off and merging point for controlling flow of the system water to balance a flow rate in the piping 2 with that in the piping 2A for the cation exchange resin column 7 and mixed bed resin column 6.

The piping 2 is further provided with the heater/cooler 4, downstream of the piping 2A merging point, for heating or cooling the system water, and the piping 2B branches off from the piping 2 downstream of the heater/cooler 4 to run in parallel to the piping 2.

The piping 2B is provided with the valve 108, catalyst column 8, water quality monitor 19 and valve 110, in this order, where the column 8 holds a catalyst (preferably of a noble metal, e.g., Ru, Pt or Rh, or of the noble metal supported by activated carbon) for decomposing the reduction decontaminating agent (described later in detail), the monitor 19 is for confirming the reduction decontaminating agent decomposition conditions (described later in detail), and valves 108 and 109 for controlling flow of the system water towards the column 8 and monitor 19 (e.g., flow control or blocking of the passage). The piping 2B joins in the piping 2 downstream of the valve 110.

The piping 2C branches off from the piping 2B upstream of the catalyst column 8, and is provided with the hydrogen peroxide solution tank 10, from which hydrogen peroxide necessary for decomposing the catalyst is supplied, hydrogen peroxide injection pump 9, and valve 107 for controlling flow of hydrogen peroxide from the piping 2C to piping 2B (e.g., flow control, or blocking or isolation of the passage).

The piping 2 is also provided with the valve 109 between the piping 2B branching-off and merging point for controlling flow of the system water towards the catalyst column 8.

The piping 2 is further provided with the piping 2D, 2E, 2F and 2G, in this order, downstream of the piping 2B merging point.

The piping 2D is provided with the oxalic acid solution tank 11, from which oxalic acid as a reduction decontaminating agent (described later in detail) is injected, oxalic acid injection pump 12, and valve 111 for controlling flow of oxalic acid from the piping 2D to piping 2A (e.g., flow control, or blocking, closing or isolation of the passage).

The piping 2E is provided with the hydrazine solution tank 13, from which hydrazine is supplied for pH adjustment (described later in detail), hydrazine injection pump 14, and valve 112 for controlling flow of hydrazine from the piping 2E to piping 2A (e.g., flow control, or blocking, closing or isolation of the passage).

The piping 2F is provided with a potassium permanganate solution tank 15, from which potassium permanganate as an oxidation decontaminating agent (described later in detail) is injected, potassium permanganate injection pump 16, and valve 113 for controlling flow of potassium permanganate from the piping 2F to piping 2A (e.g., flow control, or blocking, closing or isolation of the passage).

The piping 2G is provided with the hydrogen peroxide solution tank 20, from which hydrogen peroxide necessary for removing iron oxalate (described later in detail) is supplied, hydrogen peroxide injection pump 21, and valve 117 for controlling flow of hydrogen peroxide from the piping 2G to piping 2A (e.g., flow control, or blocking, closing or isolation of the passage).

The piping 2H branches off from the piping 2 downstream of the circulation pump 3 and upstream of the piping 2A branching-off point, and is provided with the supply/discharge valve 115 for supplying water to, or discharging from, the system. The piping 2J branches off from the piping 2 downstream of the piping 2B merging point and upstream of the piping 2D branching-off point, and is provided with the vent 116 for discharging the gas or the like evolved during the chemical decontamination process from the piping 2.

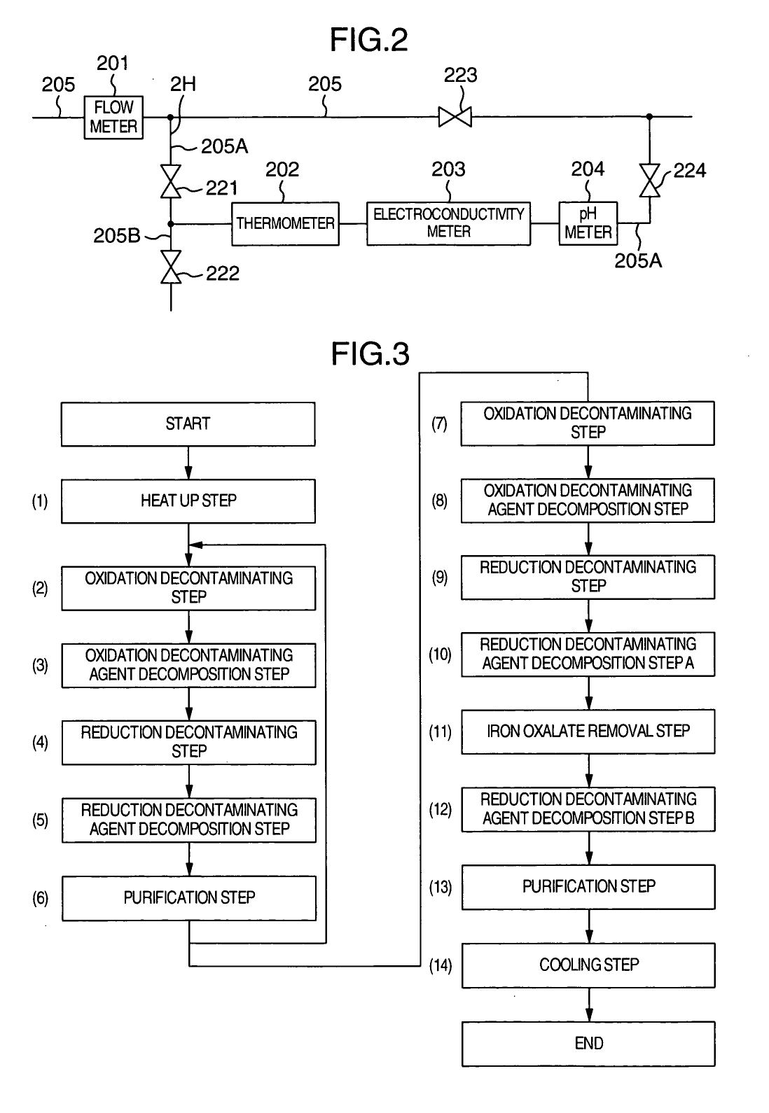

FIG. 2 is a system flow chart illustrating one detailed structure example of the water quality monitors 17, 18 and 19 for the chemical decontamination unit 300.

Referring to FIG. 2, the water quality monitor system has the piping 205, in which water flowing through the pipings 2, 2A and 2B (hereinafter referred to as system water) flows. It is provided, first of all, with the flow meter 201 for measuring flow rate of the system water. The piping 205A branches off from the piping 205 downstream of the flow meter 201 to run in parallel to the piping 2.

The piping 205A is provided with the thermometer 202, electroconductivity meter 203 and pH meter 204, in this order, for measuring temperature, electroconductivity and pH of system water, respectively, and also with the valve 221 upstream of the thermometer 202 and valve 224 downstream of the pH meter for controlling flow of water for these analyzers (e.g., flow control or blocking or closing of the passage). The piping 205A rejoins the piping 205 downstream of the valve 224.

The piping 205B branches off from the piping 205A upstream of the thermometer 202, and is provided with the sampling valve 222, by which the system water is sampled for analyzing concentrations of metallic ion, radioactivity, incorporated decontaminating agent and hydrogen peroxide present in the water.

The piping 205 is also provided with the valve 223 between the piping 205A branching-off and merging point for controlling flow of the system water to balance a flow rate in the piping 205 with that in the piping 205A for the thermometer 202, electroconductivity meter 203 and pH meter 204.

FIG. 3 outlines the overall steps of the chemical decontamination method of this embodiment.

Referring to FIG. 3, the chemical decontamination method of this embodiment starts with the heat up step.

(1) Heat Up Step

In the heat up step, the water supply/discharge valve 115 is opened to supply water to the chemical decontamination unit 300, and the valves 101, 104, 109 and 114 are opened while keeping the other valves closed to circulate system water by the circulation pump 3, where the system water is heated to a given level (e.g., 90±10° C., but below its boiling point).

The heat up step (1) is followed by the oxidation decontaminating step (2), oxidation decontaminating agent decomposition step (3), reduction decontaminating step (4), reduction decontaminating agent decomposition step (5), and purification step (6). These steps (2) to (6) may be carried out once or more times.

Radionuclides evolved in a nuclear power plant are included in an oxide film (of iron-based oxide, e.g., hematite (α-Fe₂O₃), nickel ferrite (NiFe₂O₄) or magnetite (Fe₃O₄); or chromium-based oxide, e.g., chromium oxide (Cr₂O₃) or iron chromite (FeCr₂O₄)) present on metallic parts for components, pipings and systems which contains them in a radionuclide-contaminated primary coolant system, and for other components and pipings. An iron-based oxide is highly soluble in an acid and reducing agent, whereas chromium-based one in an oxidizing agent. Therefore, a reduction decontaminating agent and oxidation decontaminating agent are alternately used to remove iron-based and chromium-based oxides.

(2) Oxidation Decontaminating Step

When the system is heated to a given temperature level by the heat up step (1), the valve 113 is opened and the potassium permanganate injection pump 16 is started, to start injecting potassium permanganate into the system from the potassium permanganate solution tank 15. The system water flowing through the piping 2 is sampled to determine the potassium permanganate concentration by the water quality monitor 17. When the concentration reaches a given level (e.g., 200 to 500 ppm as a preferable level), the potassium permanganate injection pump 16 is stopped and the valve 113 is closed.

Potassium permanganate injection may be controlled by determining beforehand its quantity necessary for securing the given concentration level from quantity of the system water by the following formula:

(Quantity of potassium permanganate to be injected)=(Concentration of potassium permanganate in the system water)×(Quantity of the system water)/(Concentration of potassium permanganate in the tank 15).

The oxidation decontaminating step is carried out for, e.g., 4 to 8 hours, while the potassium permanganate concentration is kept at a given level, to remove a chromium-based oxide present in the oxide film in the decontamination area 1.

(3) Oxidation Decontaminating Agent Decomposition Step

On completion of the oxidation decontaminating step (2), the valve 111 is opened and the oxalic acid injection pump 12 is started, to start injecting oxalic acid into the system from the oxalic acid solution tank 11. Known that one mol of the permanganate ion reacts with 5 mols of oxalic acid to be decomposed into the manganese ion, carbon dioxide, water and hydrogen ion, a given quantity (e.g., around 1.5 times of the stoichiometric requirement) of oxalic acid is injected to decompose the permanganate ion as an oxidation decontaminating agent.

On completion of injecting a given quantity of oxalic acid, the oxalic acid injection pump 12 is stopped. Completion of the decomposition is confirmed by analyzing the water sample by the water quality monitor 17 to observe that it turns transparent from the purple color characteristic of potassium permanganate.

(4) Reduction Decontaminating Step

On completion of the oxidation decontaminating agent decomposition step (3), the valves 103a and 103b are opened to start supplying the system water to the cation exchange resin column 7 while adjusting opening of the valve 104. Next, the valve 111 is opened and the oxalic acid injection pump 12 is started, to start injecting oxalic acid into the system from the oxalic acid solution tank 11, in which oxalic acid is kept dissolved. The valve 112 is opened to start injecting hydrazine into the system from the hydrazine solution tank 13, almost simultaneously with starting the injection of oxalic acid, by intermittently operating the hydrazine injection pump 14.

Injection of oxalic acid is stopped by stopping the oxalic acid injection pump 12 and closing the valve 111, when its concentration reaches a given level (e.g., 2000 to 3000 ppm as a preferable level), determined by the water quality monitor 17, which monitors the water sample. Oxalic acid injection may be controlled by determining beforehand its quantity necessary for securing the given concentration level after taking into consideration quantity of the system water and that of oxalic acid consumed for decomposition of the permanganate ion by the following formula:

(Quantity of oxalic acid to be injected)={(Molar concentration of oxalic acid 5 times higher than that of potassium permanganate injected during the oxidation step)+(Given concentration of oxalic acid in the system water)}×(Quantity of the system water)/(Concentration of oxalic acid in the oxalic acid solution tank 11).

Make-up hydrazine is also required to compensate for the quantity captured to a certain extent by the cation exchange resin column 7. Injection of hydrazine is continued until pH level in the system water reaches a given level (e.g., pH of around 2.5 as a preferable level), determined by the pH meter in the water quality monitor 18, when the hydrazine injection pump 14 is stopped and valve 112 is closed.

The reduction decontaminating step is carried out for, e.g., 4 to 15 hours, while the oxalic acid and hydrazine concentration are kept at a given level, to remove an iron-based oxide present in the oxide film in the decontamination area 1.

(5) Reduction Decontaminating Agent Decomposition Step

On completion of the reduction decontaminating step (4), the valves 108 and 110 are opened to start supplying the system water to the catalyst column 8 while adjusting opening of the valve 109 to control water flow rate. At the same time, the valve 107 is opened and the hydrogen peroxide injection pump 9 is started, to start injecting hydrogen peroxide into the system from the hydrogen peroxide solution tank 10. This allows oxalic acid ((COOH)₂) and hydrazine (N₂H₄) as reduction decontaminating agents to react with hydrogen peroxide (H₂O₂) to be decomposed into carbon dioxide (CO₂), nitrogen (N₂) and water (H₂O) by the following reactions:

(COOH)₂+H₂O₂=2CO₂+2H₂O

N₂H₄+2H₂O₂=N₂+4H₂O

The ion eluted out is captured by the cation exchange resin column 7.

The system water flowing in the piping 2B is sampled to determine oxalic acid and hydrazine concentration by the water quality monitor 19. When oxalic acid and hydrazine are decomposed to an insufficient extent, quantity of hydrogen peroxide to be injected is increased, as required.

When their concentrations are decreased to the measurable limit (around 10 ppm for each of oxalic acid and hydrazine), injection of hydrogen peroxide is stopped by stopping the hydrogen peroxide injection pump 9 and closing the valve 107, and supplying water to the catalyst column 8 is stopped by closing the valves 108 and 110.

Hydrogen peroxide injection may be controlled by determining the required quantity based on the oxalic acid and hydrazine concentration of the system water sample, determined by the water quality monitor, by the following formula:

(Quantity of hydrogen peroxide to be injected)={2×(Molar concentration of hydrazine in the system water)+(Molar concentration of oxalic acid in the system water)}×(Quantity of the system water passing through the catalyst column)/(Molar concentration in the tank 10).

(6) Purification Step

On completion of the reduction decontaminating agent decomposition step (5), the valves 103a and 103b are closed while keeping the valves 102a and 102b opened to start supplying the system water to the mixed bed resin column 6 as a radioactive substance removal unit. The mixed bed resin column 6 removes substances eluted out as a result of the chemical decontaminating and residual decontaminating agents which cannot be removed by the cation exchange resin column 7 during the reduction decontaminating step (4) and reduction decontaminating agent decomposition step (5). The purification step needs the system water to be circulated while being kept at a given temperature level (e.g., around 60° C.) or lower by the cooler 5, because an anion exchange resin commonly used in the mixed bed resin column 6 tends to deteriorate in hot water. This step is carried out for, e.g., around 6 to 12 hours.

Of the series of the procedures (2)-(6) consisting of the oxidation decontaminating step (2), oxidation decontaminating agent decomposition step (3), reduction decontaminating step (4), reduction decontaminating agent decomposition step (5) and purification step (6), the oxidation decontaminating step (2) and oxidation decontaminating agent decomposition step (3) may be by-passed, when concentration of Cr included in the surface oxide film in the decontamination area 1 is not high. However, these steps should be carried out, when concentration of Cr included in the surface oxide film in the decontamination area 1 increases by, e.g., hydrogen water chemical operation.

The steps (2) to (6), carried out once or more, are followed by the oxidation decontaminating step (7), oxidation decontaminating agent decomposition step (8) and reduction decontaminating step (9), in this order. Description of these steps (7) to (9) is omitted, because they are similar to the above-described oxidation decontaminating step (2), oxidation decontaminating agent decomposition step (3), reduction decontaminating step (4), respectively.

(10) Reduction Decontaminating Agent Decomposition Step A (Before Suspension)

The reduction decontaminating step (4) is followed by the reduction decontaminating agent decomposition step A, whose procedure is basically the same as that for the reduction decontaminating agent decomposition step (5). More specifically, the valves 108 and 110 are opened to start supplying the system water to the catalyst column 8, and, at the same time, the valve 107 is opened to start injecting hydrogen peroxide into the system.

The reduction decontaminating agent decomposition step A is temporarily suspended, when concentration of oxalic acid in the system water, sampled and analyzed by the water quality monitor 17, decreases to 100 ppm (more preferably 50 ppm). This procedure is one of the characteristics of this embodiment of the present invention, where injection of hydrogen peroxide is stopped by stopping the hydrogen peroxide injection pump 9 and closing the valve 107, and supplying water to the catalyst column 8 is stopped by closing the valves 108 and 110. This step is followed by the iron oxalate removal step (11).

(11) Iron Oxalate Removal Step

In this step, the valves 103a and 103b are closed while keeping the valves 104 and 109 opened, to stop supplying water to the cation exchange resin column 7, where the system water flows only through the valve 104 while by-passing the cation exchange resin column 7. Then, the valve 117 is opened, to operate the hydrogen peroxide injection pump 21 intermittently. This allows hydrogen peroxide to be injected into the system from the hydrogen peroxide solution tank 20, to start decompose/remove iron oxalate deposited on the surfaces in the decontamination area 1.

The reaction involved is represented by the formula (1):

2Fe(C₂O₄)+H₂O₂+2H₂O=(4/3)Fe(OH)₃+(2/3)H₃Fe(C₂O₄)₃ (1)

This reaction transforms iron oxalate Fe(C₂O₄) deposited into more water-soluble iron oxalate (⅔)H₃Fe(C₂O₄)₃, which is removed after being dissolved in water.

In this step, injection of hydrogen peroxide is controlled in such a way to keep its concentration at a given level (e.g., 1 to 50 ppm, more preferably 5 to 20 ppm) in the system water in the piping 2, sampled and analyzed by water quality monitor 17. When the concentration reaches the given level, injection of hydrogen peroxide is stopped by stopping the hydrogen peroxide injection pump 21 and closing the valve 117.

Hydrogen peroxide injection may be controlled by determining its quantity necessary for securing the given concentration level from quantity of the system water by the following formula:

(Quantity of hydrogen peroxide)=(Concentration of hydrogen peroxide in the system water)×(Quantity of the system water)/(Concentration of hydrogen peroxide in the hydrogen peroxide tank 20).

The system water is circulated for a given time (e.g., 0.5 to 2 hours, preferably) while keeping the hydrogen peroxide concentration at a given level, to remove iron oxalate deposited on the surfaces in the decontamination area 1 during the reduction decontaminating agent decomposition step (10).

When the system water containing hydrogen peroxide at a given concentration is circulated for a given time, the valves 108 and 110 are opened to supply the system water to the catalyst column 8, until hydrogen peroxide present therein is decomposed to a given level (e.g., preferably less than 1 ppm).

(12) Reduction Decontaminating Agent Decomposition Step B (After Restarting)

When concentration of hydrogen peroxide in the system water is decreased to a given level during the latter stage of the iron oxalate removal step (11), the reduction decontaminating agent decomposition step (10), temporarily suspended, is restarted (reduction decontaminating agent decomposition step B).

The valve 107 is opened and the pump 9 is started to start injecting hydrogen peroxide into the system from the hydrogen peroxide solution tank 10, and, at the same time, the valves 103a and 103b are opened to start supplying the system water to the catalyst column 8, as in the reduction decontaminating agent decomposition step A(10).

This allows to decompose oxalic acid ((COOH)₂) and hydrazine (N₂H₄) as reduction decontaminating agents continuously into carbon dioxide (CO₂), nitrogen (N₂) and water (H₂O), and the eluted ion to be captured by the cation exchange resin column 7. The substances eluted out in the iron oxalate removal step (11), which tries to remove iron oxalate with the aid of hydrogen peroxide, can be also removed in the cation exchange resin column 7 while it is capturing the eluted ions, which is another characteristic of this embodiment of the present invention.

The system water flowing in the piping 2B is sampled to determine oxalic acid and hydrazine concentrations by the water quality monitor 19. When their concentrations reach to measurable limit (around 10 ppm or less for each), injection of hydrogen peroxide is stopped by stopping the hydrogen peroxide injection pump 9 and closing the valve 107, and supplying water to the catalyst column 8 is stopped by closing the valves 108 and 110. Quantity of hydrogen peroxide to be injected may be determined in the same manner as in the reduction decontaminating agent decomposition step (5).

(13) Purification Step

The reduction decontaminating step B (12) is followed by this purification step, whose procedure is basically the same as that for the purification step (6) described earlier. Supply of water to the mixed bed resin column 6 and cooler 5 is continued, until its electroconductivity, determined by the water quality monitor 17, reaches to a given level (e.g., 10 μS/cm or less as a preferable level).

(14) Cooling Step

On completion of the purification step (13), the heater/cooler 4 is started to cool the system water flowing in the piping 2 to room temperature. When it is cooled to room temperature, the water supply/discharge valve 115 is opened to discharge the system water from the chemical decontamination unit 300, after stopping the circulation pump 3 and closing the valves 114 and 101.

The cooling of the system water in the cooling step (14) may be carried out simultaneously with the purification step (13). This can shorten the chemical decontamination period.

Completion of the cooling step (14) finishes all of the decontamination works.

The functions/effects of this embodiment are described below.

This embodiment is characterized by removing iron oxalate deposited in a decontamination area during the reduction decontaminating step (9), before completion of the last reduction decontaminating agent decomposition step (the reduction decontaminating agent decomposition step A (10) and reduction decontaminating agent decomposition step B (12)), which follows the step (9), by supplying a minimum quantity of hydrogen peroxide of the lowest necessary concentration onto the decontamination area 1, in the latter stage of the last reduction decontaminating agent decomposition step (at the completion of the reduction decontaminating agent decomposition step A (10)), e.g. in a stage that oxalic acid concentration becomes small to some extent, while temporarily suspending the reduction decontaminating agent decomposition step.

This is based on the two findings by the inventors of the present invention; (1) a relatively small quantity of hydrogen peroxide solution of relatively low concentration is sufficient only for removing iron oxalate deposited on a metallic material surface in the chemical decontamination area (i.e., when the treatment is not intended to the extent of forming an oxide film on the surface); and (2) re-deposition of removed iron oxalate can be prevented almost completely, if oxalic acid concentration is decreased to some extent.

### EXAMPLES

The tests conducted for the present invention are described in detail below.

(Test 1) Characteristics of Iron Oxalate Deposition in an Oxalic Acid Atmosphere

When iron oxalate is to be dissolved in water and removed during the reduction decontaminating agent decomposition step (i.e., in an atmosphere with oxalic acid as a decontaminating agent present in the system water), as is the case with the iron oxalate removal step (11), water-soluble iron oxalate (⅔)H₃Fe(C₂O₄)₃, transformed from 2Fe(C₂O₄) showing a tendency to deposit by the oxidation with hydrogen peroxide H₂O₂, may re-deposit in the form of iron oxalate 2Fe(C₂O₄) showing a tendency to deposit in the presence of oxalic acid at a high proportion, because corroded portion of Fe as the base material and water-soluble iron oxalate H₃Fe(C₂O₄)₃ may be reduced again with iron oxidation, which is originally serving as a reducing agent.

Therefore, the inventors of the present invention have conducted tests to empirically understand the effects of oxalic acid on deposition of iron oxalate, more specifically the effects of concentration of oxalic acid in a reduction decontaminating agent (disclosed by, e.g., JP-A-2000-105295 and JP-A-2001-74887) containing oxalic acid on quantity of iron oxalate deposited when carbon steel is immersed in the reduction decontaminating agent.

In the tests, a 2000 ppm oxalic acid solution was adjusted at a pH of 2.5 with hydrazine, and diluted with pure water to have an oxalic acid concentration of 10, 20, 50, 100, 200, 500, 1000 or 2000 ppm, to prepare the test solution. Three carbon steel specimens (each having a surface area of 10 cm²) were immersed in 500 mL of each test solution put in a 500 mL beaker using a polytetrafluoroethylene jig for 3 hours, after the solution was heated at 90±5° C. by a heater. Then, iron oxalate deposited on the carbon steel specimen was dissolved in diluted hydrochloric acid, and the resulting solution was analyzed by ion chromatography to determine the oxalic acid concentration and thereby quantity of the deposited iron oxalate as oxalic acid.

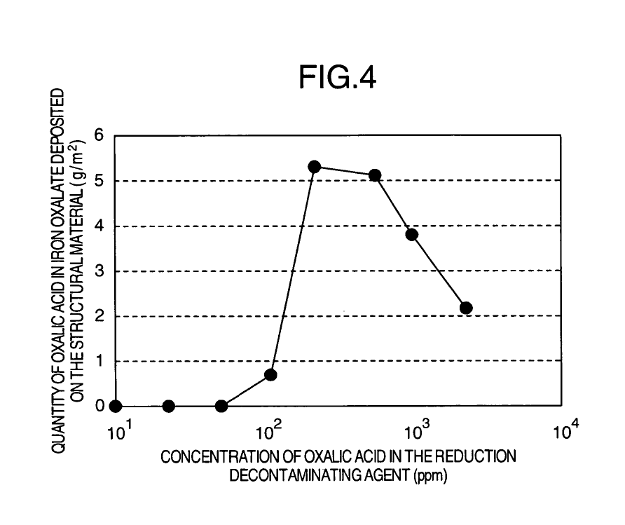

FIG. 4 shows the results, where quantity of iron oxalate deposited on the carbon steel specimen as that of oxalic acid (g/m²) (vertical axis) is plotted against concentration (ppm) of oxalic acid in the reduction decontaminating agent (horizontal axis).

As shown in FIG. 4, essentially no iron oxalate deposits on the carbon steel specimen when concentrations of oxalic acid in the reduction decontaminating agent are 10, 20 and 50 ppm. It starts to deposit on the carbon steel specimen as the concentration exceeds 50 ppm, but the deposited quantity is limited to around 0.8 g/m² at a concentration of 100 ppm. However, the deposited quantity sharply increases as the concentration exceeds 100 ppm, to 5 g/m² or more at 200 and 500 ppm.

It is therefore concluded, based on the above results, that essentially no iron oxalate deposits on the carbon steel specimen when concentration of oxalic acid in the reduction decontaminating agent is 100 ppm or less, more preferably 50 ppm or less, and that iron oxalate deposits notably as the oxalic acid concentration exceeds 100 ppm. In other words, there is little possibility for iron oxalate to re-deposit when hydrogen peroxide is incorporated to remove iron oxalate, e.g., during the latter stage of the reduction decontaminating agent decomposition step, but it may re-deposit, e.g., during the initial stage of the reduction decontaminating agent decomposition step, even when it is removed in the presence of hydrogen peroxide incorporated.

(Test 2) Characteristics of Iron Oxalate Removal with Low Concentration Hydrogen Peroxide

The results of the test 1 indicate that iron oxalate could be possibly dissolved and removed even during the reduction decontaminating agent decomposition step while preventing its re-deposition, if the step is carried out in an atmosphere of oxalic acid of low concentration. However, when hydrogen peroxide H₂O₂ is incorporated excessively (or H₂O₂ of excessively high concentration is incorporated) to remove iron oxalate, it will remain unconsumed, with the results that an additional step for decomposing the surplus H₂O₂ itself may be required downstream of the reduction decontaminating agent decomposition step, as is the case with the conventional technique.

Therefore, the inventors of the present invention have conducted tests to empirically grasp required quantity of hydrogen peroxide for removing iron oxalate, more specifically the effects of concentration of hydrogen peroxide incorporated in a reduction decontaminating agent (disclosed by, e.g., JP-A-2000-105295 and JP-A-2001-74887) on characteristics of removing iron oxalate deposited on a carbon steel specimen.

In the tests, a 2000 ppm oxalic acid solution adjusted at a pH of 2.5 with hydrazine was heated in a beaker at 90±5° C. by a heater, and a carbon steel specimen was immersed in the solution for 4 hours to deposit iron oxalate on the specimen.

The 2000 ppm oxalic acid solution adjusted at a pH of 2.5 with hydrazine was diluted with pure water to have an oxalic acid concentration of 20 ppm (at which no iron oxalate will re-deposit, as confirmed in the test 1).

Next, 100 mL of the diluted solution was heated in a 100 mL beaker at 90+5° C., and a carbon steel specimen on which iron oxalate was deposited was immersed in the solution using a jig. Then, hydrogen peroxide was incorporated in the solution at a varying concentration (case 1:10 ppm; case 2:20 ppm; case 3:50 ppm; and case 4:100 ppm) to remove iron oxalate for 5 to 20 minutes. Quantity of iron oxalate was determined in the same manner as in the test 1.

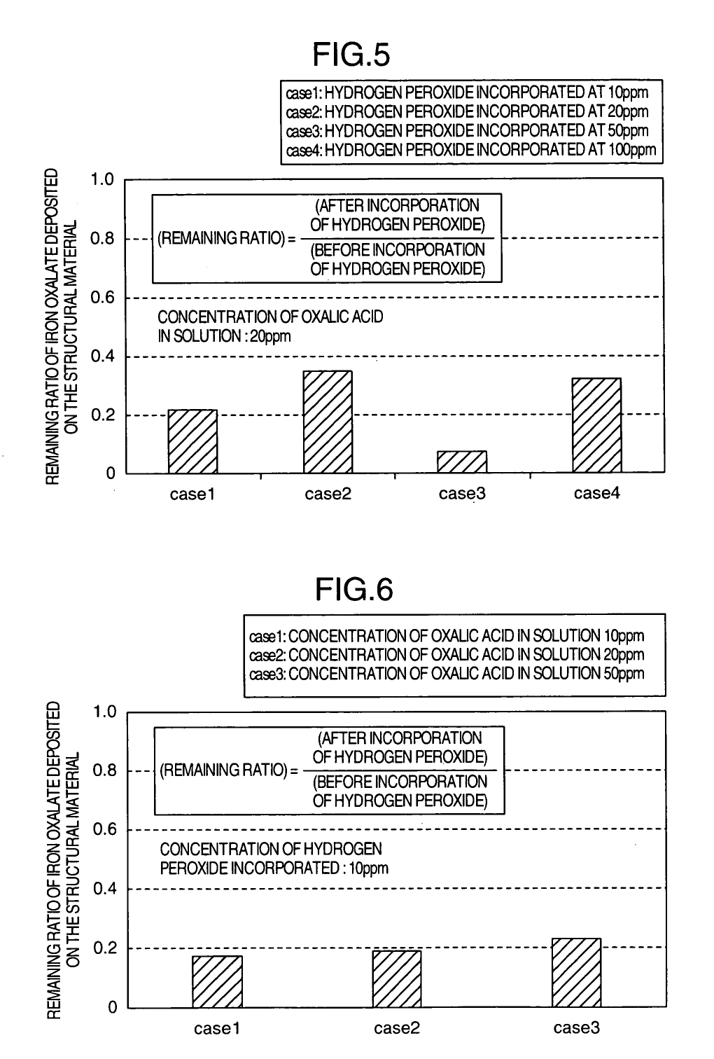

FIG. 5 shows the results, i.e., ratio of iron oxalate remaining on the structural material after the treatment with hydrogen peroxide to iron oxalate deposited before the treatment for each of cases 1, 2, 3 and 4.

As shown in FIG. 5, the ratio of remaining iron oxalate is within a range of 0.2±0.15 in all cases 1, 2, 3 and 4, which indicates that incorporation of hydrogen peroxide at least at 10 ppm (concentration for case 1) can produce an almost sufficient iron oxalate removing effect, and that increasing hydrogen peroxide concentration beyond the above level little accelerates the reaction for removing iron oxalate, removal rate remaining essentially constant.

(Test 3) Characteristics of Iron Oxalate Re-Deposition in an Atmosphere with Incorporated Hydrogen Peroxide

There are the iron oxalate removal characteristics that deposition of iron oxalate can be prevented in an atmosphere containing oxalic acid at a low concentration, 100 ppm or less, as confirmed by the test 1, and deposited iron oxalate can be removed with hydrogen peroxide incorporated at 10 ppm in an atmosphere containing oxalic acid at 20 ppm, as confirmed by the test 2.

The inventors of the present invention have conducted the tests, based on the test 1 and 2 results, to simulate dissolution/removal of iron oxalate during the actual reduction decontaminating agent decomposition step whether the effect of preventing re-deposition of iron oxalate can be produced in an atmosphere containing oxalic acid at the relatively low concentration adopted in the test 1 with the minimum quantity of hydrogen peroxide adopted in the test 2, in other words, whether re-deposition of iron oxalate can be prevented by incorporating hydrogen peroxide after iron oxalate is removed.

In the tests, a 2000 ppm oxalic acid solution adjusted at a pH of 2.5 with hydrazine was first heated in a beaker at 90±5° C. by a heater, and a carbon steel specimen was immersed in the solution for 4 hours to deposit iron oxalate on the specimen.

The 2000 ppm oxalic acid solution adjusted at a pH of 2.5 with hydrazine was diluted with pure water to have a varying oxalic acid concentration (case 1:10 ppm; case 2:20 ppm; and case 3:50 ppm).

Next, 100 mL of the diluted solution was heated in a 100 mL beaker at 90±5° C., and a carbon steel specimen on which iron oxalate was deposited was immersed in the solution using a jig. Then, hydrogen peroxide was incorporated in the solution at 10 ppm to remove iron oxalate for 5 to 20 minutes.

FIG. 6 shows the results, i.e., ratio of iron oxalate remaining on the structural material after the treatment with hydrogen peroxide to iron oxalate deposited before the treatment for each of cases 1, 2 and 3.

As shown in FIG. 6, the ratio of remaining iron oxalate is around 0.2 or less in all cases 1, 2 and 3, which indicates that incorporation of hydrogen peroxide at 50 ppm or less can prevent re-deposition of iron oxalate almost completely.

It is thus found that iron oxalate can be removed without causing its re-deposition by incorporating hydrogen peroxide at a relatively low concentration (e.g., 50 ppm or less, more preferably 20 ppm or less), when concentration of oxalic acid in the reduction decontaminating agent decreases to a relatively low level (e.g., 100 ppm or less, more preferably 50 ppm or less).

This embodiment temporarily suspends the reduction decontaminating agent decomposition step when concentration of oxalic acid in the system water decreases to 100 ppm (more preferably 50 ppm) during the reduction decontaminating agent decomposition step A, to start the iron oxalate removal step (11), for which hydrogen peroxide is injected to 1 to 50 ppm, more preferably 5 to 20 ppm. This can remove iron oxalate from the decontamination area 1 without causing its re-deposition before completion of the reduction decontaminating agent decomposition step (i.e., while the reduction decontaminating agent decomposition step B is suspended), unlike the conventional technique, which tries to remove iron oxalate with the aid of hydrogen peroxide subsequent to completion of the reduction decontaminating agent decomposition step. Moreover, this embodiment can prevent the ion exchange resin (or ion exchange membrane) from being deteriorated by hydrogen peroxide by supplying hydrogen peroxide while the valves 103a and 103b are closed to block the passage to the cation exchange resin column 7. Still more, this embodiment can also achieve, during the reduction decontaminating agent decomposition step (12) subsequent to the iron oxalate removal step (11), removal of substances eluted out as a result of incorporation of hydrogen peroxide, as discussed earlier.

As described above, this embodiment, removing iron oxalate by the above procedure, can dispense with additional post-treatment steps downstream of the reduction decontaminating agent decomposition step, e.g., iron oxalate removing step in the presence of hydrogen peroxide or the like, step for decomposing surplus hydrogen peroxide or the like and step for removing eluted substances, unlike the conventional technique, which needs all of these post-treatment steps separately. This reduces process time for these post-treatment steps and hence shortens the total decontamination process.

The first embodiment described above is provided with the hydrogen peroxide solution tank 20, hydrogen peroxide injection pump 21 and valve 117 for the iron oxalate removal step (11), in addition to the hydrogen peroxide solution tank 10, hydrogen peroxide injection pump 9 and valve 107 for the reduction decontaminating agent decomposition steps (5), (10) and (12). However, the present invention is not limited to the above design configuration. For example, the hydrogen peroxide solution tank 20, hydrogen peroxide injection pump 21 and valve 117 may be omitted. In this case, the hydrogen peroxide injection pump 9 is started to inject hydrogen peroxide into the system from the hydrogen peroxide solution tank 10 via the valve 107 also for the iron oxalate removal step (11).

This modification brings the merit of reduced investment, because the valve 117, hydrogen peroxide injection pump 21 and hydrogen peroxide solution tank 20 come not to be required.

The second embodiment of the present invention is described by referring to FIG. 3.

This embodiment removes iron oxalate in parallel with the reduction decontaminating agent decomposition step without suspending (stopping) this step.

The decontamination method of this embodiment needs the same steps shown in FIG. 3 as in the first embodiment, except for the reduction decontaminating agent decomposition step A (10), iron oxalate removal step (11) and reduction decontaminating agent decomposition step B (12). Therefore, only these 3 steps are described, where the corresponding step number is marked with a dash.

(10′) Reduction Decontaminating Agent Decomposition Step A

In this embodiment, the step (10′) is carried out in the same manner as in the first half of the reduction decontaminating agent decomposition step (10) after the reduction decontaminating step (9). More specifically, the valves 108 and 110 are opened to start supplying the system water to the catalyst column 8, while adjusting flow rate of the system water to the catalyst column 8 by the valve 109. At the same time, the valve 107 is opened and hydrogen peroxide injection pump 9 is started to start injecting hydrogen peroxide into the system from the hydrogen peroxide solution tank 10. Quantity of hydrogen peroxide to be injected may be determined in the same manner as in the reduction decontaminating agent decomposition step (5).

In the first embodiment, the reduction decontaminating agent decomposition step A (10) is suspended to be followed by the iron oxalate removal step (11), when concentration of oxalic acid in the system water, sampled and analyzed by the water quality monitor 17, reaches to 100 ppm (more preferably 50 ppm), after injection of hydrogen peroxide is stopped by stopping the hydrogen peroxide injection pump 9 and closing the valve 107, and supplying water to the catalyst column 8 is stopped by closing the valves 108 and 110. In this embodiment, on the other hand, the step (10′) is directly followed by the iron oxalate removal step (11′) without being suspended, even when oxalic acid concentration reaches to 100 ppm (more preferably 50 ppm).

(11′) Iron Oxalate Removal Step

In this step, the valves 103a and 103b are closed to stop supplying water to the cation exchange resin column 7, and then the valve 117 is opened and the hydrogen peroxide injection pump 21 is operated intermittently to inject hydrogen peroxide into the system from the hydrogen peroxide solution tank 20, in such a way to secure concentration of hydrogen peroxide in the system water at a given level (e.g., 1 to 50 ppm, more preferably 5 to 20 ppm) to dissolve/remove iron oxalate deposited on the surfaces in the decontamination area 1. Quantity of hydrogen peroxide to be injected is adjusted to secure a given concentration of hydrogen peroxide in the system water, sampled and analyzed by the water quality monitor 17.

After the system water is circulated for a given time (e.g., 0.5 to 2 hours, preferably) while keeping the hydrogen peroxide concentration at a given level, an injection of hydrogen peroxide of system water from the hydrogen peroxide solution tank 20 is stopped by stopping the hydrogen peroxide injection pump 21 and closing the valve 117, and supplying the system water to the cation exchange resin column 7 is reopened by opening the valves 103a and 103b, when concentration of hydrogen peroxide in the system water, sampled and analyzed by the water quality monitor 17, reaches a given level (e.g., 1 ppm or less as a preferable level).

In this case, hydrogen peroxide is continuously injected into the system from the hydrogen peroxide solution tank 20. However, quantity of hydrogen peroxide supplied from the hydrogen peroxide solution tank 10 is smaller than that of hydrogen peroxide from the hydrogen peroxide solution tank 20. Therefore, quantity of hydrogen peroxide to be injected may be determined in the same manner as in the reduction decontaminating agent decomposition step (5).

(12′) Reduction Decontaminating Agent Decomposition Step B

The reduction decontaminating agent decomposition step B (12′) injects hydrogen peroxide into the system from the hydrogen peroxide solution tank 10 and supplies the system water to the cation exchange resin column 7 continuously from the previous iron oxalate removal step (11′), to decompose oxalic acid and hydrazine as the reduction decontaminating agents, and to capture the eluted ion by the cation exchange resin column 7, as described earlier. At the same time, it also removes substances eluted out as a result of the treatment with hydrogen peroxide for removing iron oxalate in the previous iron oxalate removal step (11′), like the reduction decontaminating agent decomposition step B (12), described earlier.

The system water flowing in the piping 2B is sampled to determine oxalic acid and hydrazine concentrations by the water quality monitor 19. When their concentrations reach to the measurable limit (around 10 ppm for each), injection of hydrogen peroxide is stopped by stopping the hydrogen peroxide injection pump 9 and closing the valve 107, and supplying water to the catalyst column 8 is stopped by closing the valves 108 and 110. Quantity of hydrogen peroxide to be injected may be determined in the same manner as in the reduction decontaminating agent decomposition step (5).

This embodiment produces the effects similar to those by the first embodiment.

Moreover, this embodiment removes iron oxalate in parallel with decomposition of the reduction decontaminating agent unlike the first embodiment, which suspends the decomposition step, thus producing an additional effect of simplified valve operation, among others.

The first and second embodiments of the present invention supply hydrogen peroxide during the respective iron oxalate removal step (11) and (11′) while closing the valves 103a and 103b and then blocking the passage towards the cation exchange resin column 7 to prevent deterioration of the resin in the column 7. However, the present invention is not limited to the above design configuration. For example, hydrogen peroxide may be supplied from the hydrogen peroxide solution tank 20 by opening the valve 117 while opening the valves 103a and 103b and also opening (communicating with) the passage towards the cation exchange resin column 7 in consideration of actual flow rate or the like, and then the passage to the cation exchange resin column 7 is closed before the hydrogen peroxide reaches the column 7 while keeping the valves 103a and 103b opened. This modification should produce the similar effects.

The first and second embodiments of the present invention include the catalyst column 8 containing a catalyst as a reduction decontaminating agent decomposition unit. However, the catalyst column 8 may be replaced by a UV-aided decomposition unit. Moreover, cation exchange resin column 7 or mixed bed resin column 6, used as a radioactive substance removal unit (radioactivity removal unit) in these embodiments, may be replaced by a filter, cation exchange membrane or anion exchange membrane.

Still more, the first and second embodiments of the present invention remove iron oxalate deposited on a metallic part with the aid of hydrogen peroxide. However, hydrogen peroxide may be replaced by another oxidation decontaminating agent at least as oxidation as hydrogen peroxide and reacting to become harmless, e.g., ozone. Such an oxidation decontaminating agent can produce the similar effects.

It should be further understood by those skilled in the art that although the foregoing description has been made on embodiments of the invention, the invention is not limited thereto and various changes and modifications may be made without departing from the spirit of the invention and the scope of the appended claims.

Effects Of The Invention

The present invention can dispense with a separate step for removing iron oxalate in the presence of hydrogen peroxide, step for decomposing surplus hydrogen peroxide and step for removing eluted substances as post-treatment steps downstream of the reduction decontaminating agent decomposition step, reduction process time for these post-treatment steps and hence shortening the total decontamination process.

What is claimed is:

1. A method of chemical decontamination for removing a radionuclide from a surface of metallic part contaminated with the radionuclide, comprising:
a reduction decontaminating step for decontamination using a radioactive substance removal unit by supplying a reduction decontaminating agent containing oxalic acid onto a decontamination area of the metallic part surface and a subsequent reduction decontaminating agent decomposition step for decomposing the reduction decontaminating agent,
wherein hydrogen peroxide or ozone is supplied onto the decontamination area in a state so as to block a passage towards the radioactive substance removal unit during the reduction decontaminating agent decomposition step.

2. A method of chemical decontamination for removing a radionuclide from a surface of metallic part contaminated with the radionuclide, comprising:
a reduction decontaminating step for decontamination using a radioactive substance removal unit by supplying a reduction decontaminating agent containing oxalic acid onto a decontamination area of the metallic part surface and a subsequent reduction decontaminating agent decomposition step for decomposing the reduction decontaminating agent,
wherein hydrogen peroxide or ozone is supplied into a passage getting through the decontamination area in a state so as to communicate with the radioactive substance removal unit during the reduction decontaminating agent decomposition step, and
the communication with the radioactive substance removal unit is closed before the hydrogen peroxide or ozone supplied reaches the radioactive substance removal unit.

3. The method of chemical decontamination according to claim 1, wherein the passage towards said radioactive substance removal unit is closed when oxalic acid concentration becomes 100 ppm or less during said reduction decontaminating agent decomposition step, and hydrogen peroxide or ozone is supplied onto said decontamination area while keeping the passage closed.

4. The method of chemical decontamination according to claim 1, wherein the passage towards said radioactive substance removal unit is closed when oxalic acid concentration becomes 50 ppm or less during said reduction decontaminating agent decomposition step, and hydrogen peroxide or ozone is supplied onto said decontamination area while keeping the passage closed.

5. The method of chemical decontamination according to claim 2, wherein the passage towards said radioactive substance removal unit is closed when oxalic acid concentration becomes 100 ppm or less during said reduction decontaminating agent decomposition step, and hydrogen peroxide or ozone is supplied onto said decontamination area while keeping the passage closed.

6. The method of chemical decontamination according to claim 1, wherein the passage towards said radioactive substance removal unit is closed when oxalic acid concentration becomes 50 ppm or less during said reduction decontaminating agent decomposition step, and hydrogen peroxide or ozone is supplied onto said decontamination area while keeping the passage closed.

7. A method of chemical decontamination comprising conducting a series of steps at 2 or more times, including a reduction decontaminating step for decontamination using ion exchange resin or ion exchange membrane by supplying a reduction decontaminating agent containing oxalic acid onto a decontamination area of metallic part surface with a radionuclide deposited and a subsequent reduction decontaminating agent decomposition step for decomposing the reduction decontaminating agent using the ion exchange resin or ion exchange membrane, to elute out and remove the radionuclide from the decontamination area,
wherein hydrogen peroxide or ozone is supplied onto the decontamination area during the last reduction decontaminating agent decomposition step in a state so as to by-pass the ion exchange resin or ion exchange membrane.

8. The method of chemical decontamination according to claim 7, wherein said series of steps further include an oxidation decontaminating step for decontamination by supplying an oxidation decontaminating agent onto said decontamination area and a subsequent oxidation decontaminating agent decomposition step for decomposing the oxidation decontaminating agent.

9. The method of chemical decontamination according to claim 7, wherein a passage towards said ion exchange resin or ion exchange membrane is closed when oxalic acid concentration becomes 100 ppm or less during said reduction decontaminating agent decomposition step, and hydrogen peroxide or ozone is supplied onto said decontamination area while keeping the passage closed.

10. The method of chemical decontamination according to claim 7, wherein a passage towards said ion exchange resin or ion exchange membrane is closed when oxalic acid concentration becomes 50 ppm or less during said reduction decontaminating agent decomposition step, and hydrogen peroxide or ozone is supplied onto said decontamination area while keeping the passage closed.

11. The method of chemical decontamination according to claim 1, wherein said metallic part contains at least one type of steel selected from the group consisting of carbon steel, ferritic stainless steel, and austenitic stainless steel.

12. A method of chemical decontamination for removing a radionuclide from a surface of metallic part contaminated with the radionuclide, in which:
a reduction decontaminating agent containing oxalic acid is supplied onto a decontamination area of the metallic part surface to decontaminate the surface while using cation exchange resin or cation exchange membrane,
the step for decomposing the reduction decontaminating agent is started while using the cation exchange resin or cation exchange membrane,
the step for decomposing the reduction decontaminating agent is temporarily suspended, when a concentration of oxalic acid becomes a given level, and hydrogen peroxide or ozone is supplied onto the decontamination area while by-passing the cation exchange resin or cation exchange membrane, to remove iron oxalate deposited on the decontamination area by the supply step of the reduction decontaminating agent, and,
after the iron oxalate is removed, the step for decomposing the reduction decontaminating agent is restarted and, at the same time, substances eluted out at the time of the removal of the iron oxalate are removed.
